(19) United States
(12) Patent Application Publication
(10) Pub. No.: US 2013/0330107 A1
(43) Pub. Date: Dec. 12, 2013

(54) DEVELOPMENT APPARATUS AND IMAGE FORMING APPARATUS

(71) Applicant: KONICA MINOLTA, INC., Tokyo (JP)

(72) Inventors: Seiko ITAGAKI, Tokyo (JP); Yoshihiro HATTORI, Tokyo (JP); Daisuke UEDA, Tokyo (JP)

(73) Assignee: KONICA MINOLTA, INC., Tokyo (JP)

(21) Appl. No.: 13/904,393

(22) Filed: May 29, 2013

(30) Foreign Application Priority Data
Jun. 7, 2012 (JP) 2012-130080

(51) Int. Cl. G03G 15/09

(52) U.S. Cl. CPC G03G 15/0891
USPC 399/269

(57) ABSTRACT

A development apparatus is equipped with a first developing roller, developer supply section, a second developing roller, a developer removing part and a developer recovery section. The second developing roller is disposed on the downstream side of the first developing roller and above the first developing roller, to which the developer is delivered from the first developing roller by magnetic force. The developer supply section includes a developer circulation section and a first regulating member that regulates an amount of the developer. The developer recovered by the developer recovery section drops by gravity and is introduced into the developer circulation section.

### CROSS-REFERENCE TO RELATED APPLICATION

This application is based on Japanese Patent Application No. 2012-130080 filed on Jun. 7, 2012, the contents of which are incorporated herein by reference.

### BACKGROUND

1. Technical Field

The present invention relates to a development apparatus and an image forming apparatus.

2. Description of Related Art

A method has been proposed recently for mixing and agitating the toner and the carrier that constitute the developer, wherein a pair of screw rollers, which are set parallel to the shaft of a developing roller, is rotated to cause developer to circulate.

For example, according to the art disclosed by Publication of Unexamined Japanese Patent Application 2007-272201, a supply screw roller and a recovery screw roller are placed one above the other, and the supply screw roller is facing against a developing roller, and a transport screw roller is disposed at the slant and extends from the rear end of the recovery screw roller to the starting end of the supply roller. Under such an arrangement, the developer recovered by the recovery screw roller is supplied to the developing roller by the supply screw roller after having been scooped up by the transport screw roller.

Also, according to the art disclosed by Publication of Unexamined Japanese Patent Application 2009-8986, a supply screw roller and an agitation screw roller are placed one above the other, and the supply screw roller is facing against a developing roller, and the recovery screw roller is placed on the side of the agitation screw roller and underneath the developing roller. Under such an arrangement, the developer recovered by the recovery screw roller is supplied to the developing roller by the supply screw roller after having been scooped up via the agitation screw roller.

However, since the recovered developer in the development apparatus of the aforementioned constitution is introduced to the supply screw roller after being agitated and mixed, so that there is a developer scoop area in the developer circulation system although the concentration uniformity of the developer relative to the axial direction of the supply screw roller is superior than in the case of introducing the agent directly into the supply screw roller. Consequently, scooping up the developer becomes rate-determining in the range where images are formed at a high speed, causing retention of the developer, which can become a problem in terms of the circulation of the developer.

### SUMMARY

The present invention is made in order to solve the abovementioned problem associated with the related art, and to provide a development apparatus capable of recovering and circulating the developer from the sleeve, and for supplying it to the sleeve even in the range where images are formed at a high speed, and an image forming apparatus capable of suppressing the occurrence of a defect in an image even in the range where images are formed at a high speed.

To achieve at least one of the abovementioned objects, a development apparatus equipped with a plurality of developing rollers for developing and visualizing an electrostatic latent image formed on an image carrier by means of toner contained in a developer reflecting one aspect of the present invention includes: a first developing roller for adsorbing the developer by magnetic force; a supply section for supplying the developer to the first developing roller; a second developing roller disposed on a downstream side of the first developing roller relative to a rotation direction of the image carrier and above the first developing roller, to which the developer is delivered from the first developing roller by magnetic force; a removing part that removes off the developer adsorbed on the second developing roller; and a recovery section used for recovering the developer that is removed. The supply section includes a developer circulation section wherein the developer supplied to the first developing roller is agitated while circulating substantially in a horizontal direction, and a first regulating member that is disposed adjacent to the first developing roller and regulates an amount of the developer that flows out from the developer circulation section and adsorbed by the first developing roller. The developer that is recovered by the recovery section drops by gravity and is introduced into the developer circulation section.

To achieve at least one of the abovementioned objects, an image forming apparatus reflecting one aspect of the present invention includes a development apparatus equipped with a plurality of developing rollers for developing and visualizing an electrostatic latent image formed on an image carrier by means of toner contained in a developer, and an image carrier on which an electrostatic latent image to be developed is formed by the development apparatus. The development apparatus includes: a first developing roller for adsorbing the developer by magnetic force; a supply section for supplying the developer to the first developing roller; a second developing roller disposed on a downstream side of the first developing roller relative to a rotation direction of the image carrier and above the first developing roller, to which the developer is delivered from the first developing roller by magnetic force; a removing part that removes off the developer adsorbed on the second developing roller; and a recovery section used for recovering the developer that is removed. The supply section includes a developer circulation section wherein the developer supplied to the first developing roller is agitated while circulating substantially in a horizontal direction, and a first regulating member that is disposed adjacent to the first developing roller and regulates an amount of the developer that flows out from the developer circulation section and adsorbed by the first developing roller. The developer that is recovered by the recovery section drops by gravity and is introduced into the developer circulation section.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a cross-sectional view of assistance in explaining an image forming apparatus according to an embodiment of the present invention.

FIG. 2 is a cross-sectional view of assistance in explaining a development apparatus shown in FIG. 1.

FIG. 3 is an enlarged view of the main part of FIG. 2.

FIG. 4 is a schematic view of assistance in explaining the first developing roller shown in FIG. 3.

FIG. 5 is a schematic view of assistance in explaining the second developing roller shown in FIG. 3.

FIG. 6 is a schematic view of assistance in explaining a developer circulation section shown in FIG. 2.

FIG. 7 is a cross-sectional view of assistance in explaining a modification according to the embodiment of the present invention.

FIG. 8 is a schematic view of assistance in explaining the removing roller shown in FIG. 7.

### DETAILED DESCRIPTION

Let us now describe the embodiments of the present invention referencing the accompanied drawings.

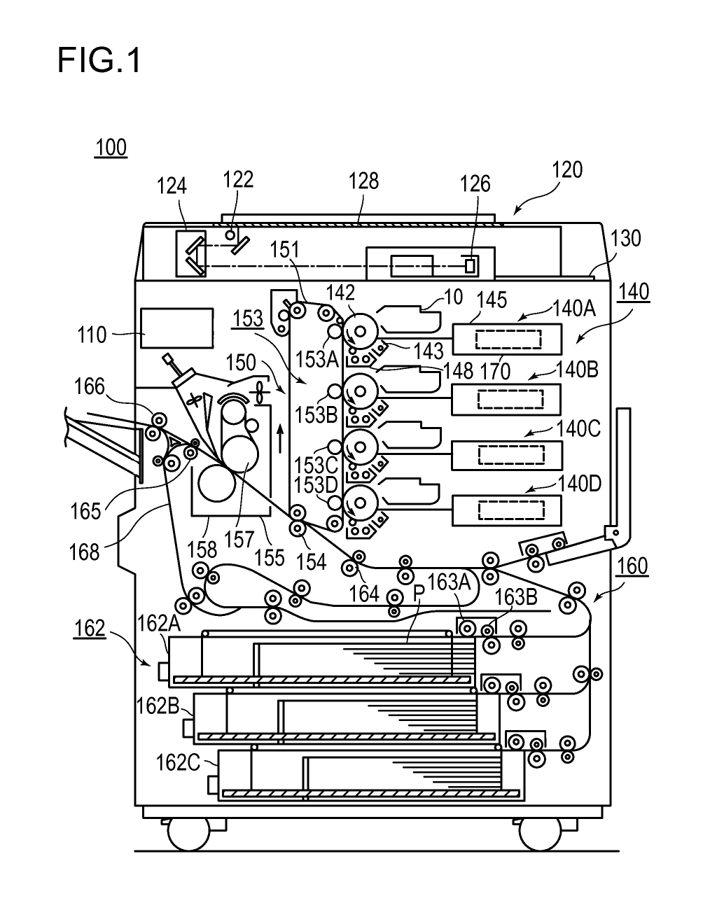

FIG. 1 is a cross-sectional view of assistance in explaining an image forming apparatus according to an embodiment of the present invention.

The image forming apparatus 100 shown in FIG. 1 is a tandem type color copying machine equipped with a controller 110, an image reading unit 120, an operation/display unit 130, an image forming device 140, an image transferring unit 150, an image fixing device 155, and a paper transporting section 160.

The controller 110 is a control circuit composed of microprocessors and others that controls various parts described above and executes various arithmetic operations in accordance with programs, and each function of the image forming apparatus 100 is effectuated as the controller 110 executes the program corresponding thereto.

The image reading unit 120 is used for generating the image data of an original document and is equipped with a light source 122, an optical system 124, and an imaging device 126. The light source 122 irradiates the document placed on an original glass plate 128, and the light reflected from it is focused via the optical system 124 on the imaging device 126 that has moved to a reading position. The imaging device 126 is composed of, for example, a line image sensor, and generates electrical signals corresponding to the intensity of the reflected light (executes photoelectric conversion). The generated electrical signals are inputted into the image forming device 140 after image processing. The image processing includes A/D conversion, shading compensation, filter processing, image compression processing, etc.

The operation/display unit 130 is composed of, for example, LCD (Liquid Crystal Display) and a keyboard. It serves as an output device for showing the user the apparatus constitution, the process status of a print job, the error occurrence status, the settings that can be currently modified, and others, as well as an input device for the user to indicate or input various instructions such as character input, various settings, starting instructions, etc. The keyboard has a plurality of keys composed of a selection key for specifying the size of paper P, a numeric keypad for specifying the number of copies to be produced and others, a start key for instructing the start of an operation, a stop key for instructing the stop of operations, and others.

The image forming device 140 uses an electrophotographic process to form an image on the paper P as a recording medium, and is composed of an image forming unit 140A to form images of yellow (Y) color, an image forming unit 140B to form images of magenta (M) color, an image forming unit 140C to form images of cyan (C) color, and an image forming unit 140D to form images of black (K) color. The developer of the electrophotographic process is composed of, for example, a nonmagnetic toner and a magnetic carrier.

Each unit of the image forming device 140 is equipped with a development apparatus 10, a photoreceptor drum 142, an electrostatic charging unit 143, an optical writing unit 145, and a cleaning device 148.

The development apparatus 10 is to develop and visualize an electrostatic latent image formed on the photoreceptor drum 142 with the help of the toner. In other words, the system forms corresponding monochromatic images of yellow, magenta, cyan, and black colors on the photoreceptor drum 142 of the respective image forming units 140A, 140B, 140C, and 140D.

The development apparatus 10 can recover the developer and cause it to circulate in a stable manner even in the range where images are formed at a high speed as described later. Therefore, the image forming apparatus 100, in which the development apparatus 10 is built in, can suppress the occurrence of a defect such as improper density in an image visualized by the toner contained in the developer.

The photoreceptor drum 142 is an image carrier having a photosensitive layer made of a synthetic resin such as polycarbonate and the like containing OPC (Organic Photo-Conductor), and is adapted to rotate at a predetermined speed. The electrostatic charging unit 143 is composed of corona discharge electrodes provided on the periphery of the photoreceptor drum 142 and charges the surface of the photoreceptor drum 142 with ions generated by the corona discharge electrodes.

The optical writing unit 145 has a built-in scanning optical device 170, and forms an electric charge pattern or electrostatic latent image corresponding to the image data inputted from the image reading unit 120 by exposing the charged photoreceptor drum 142 based on the above image data and thus lowering the potentials of the exposed areas.

The cleaning device 148 is used for maintaining the surface of the photoreceptor drum 142 in a preferable state after the monochromatic images are transferred onto an intermediate transfer belt 151 to be described later by scraping or removing residual substances such as toners and external additives left on the surface.

The image transferring unit 150 has an intermediate transfer belt 151, a primary transfer part 153, and a secondary transfer part 154. The intermediate transfer belt 151 is wound around the primary transfer part 153 and a plurality of rollers and is movably supported. The primary transfer part 153 is composed of primary transfer modules 153A, 153B, 153C, and 153D that correspond to yellow, magenta, cyan, and black colors respectively. The secondary transfer part 154 is disposed on the outside of the intermediate transfer belt 151 in such a manner as to allow the paper P to pass through between it and the intermediate transfer belt 151.

The monochromatic image of each color formed in the image forming units 140A-140D is transferred onto the intermediate transfer belt 151 by the primary transfer parts 153A-153D one after the other to form a color image by overlaying the images of yellow, magenta, cyan, and black colors on top of each other. The color image thus formed is transferred on the paper P having been transported, by means of the secondary transfer part 154.

The image fixing device 155 is used for fixing the color image transferred onto the paper P, and is equipped with a heating roller 157 and a pressure roller 158. The paper P is applied with pressure and heat as it passes between the heating roller 157 and the pressure roller 158, in order to melt the toners and fix the color image.

The paper transporting section 160 is equipped with a paper feeding part 162, a paper stop roller 164, a conveyance roller 165, a discharge roller 166, and a paper inversion part 168.

The paper feeding part 162 is equipped with paper feed trays 162A-162C that store paper P, a feed roller 163A, and a separation roller 163B. The feed roller 163A and the separation roller 163B feed out paper one sheet at a time from the paper feed trays 162A-162C to a transport route.

The paper stop roller 164 transports the paper P fed by the paper feeding part 162 to the secondary transfer part 154. The conveyance roller 165 transports the paper P arriving via the secondary transfer part 154 and the image fixing device 155 towards the discharge roller 166. The discharge roller 166 discharges the transported paper P to the outside of the apparatus.

The paper inversion part 168 is used for turning over the paper P or for forming images on both sides of the paper P by introducing the paper P arriving from the conveyance roller 165 into a transport route between the paper feed trays 162A-162C and the discharge roller 166, rather than to the transport route toward the discharge roller 166.

Next, let us describe development apparatus 10 in detail.

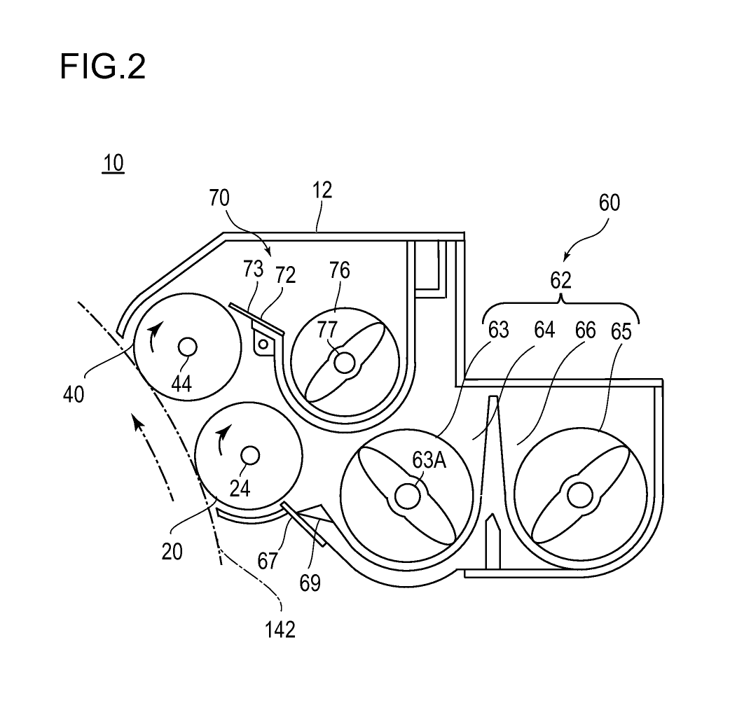

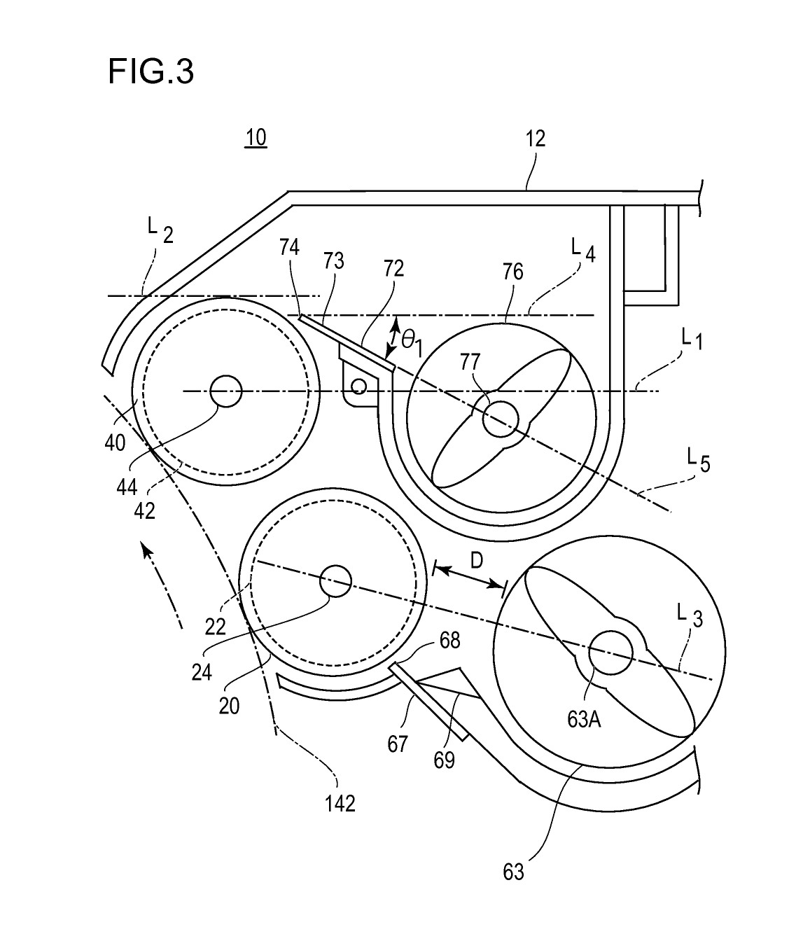

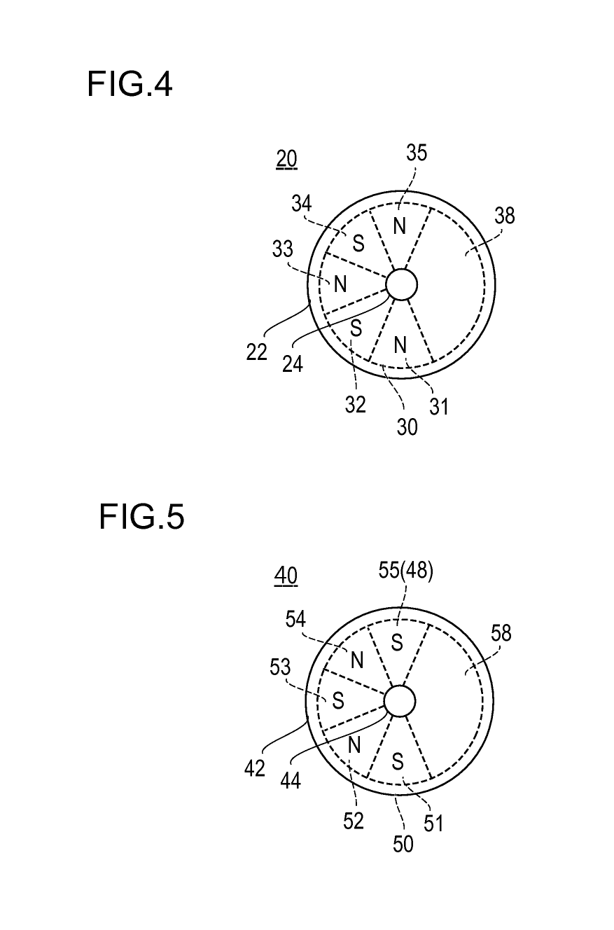

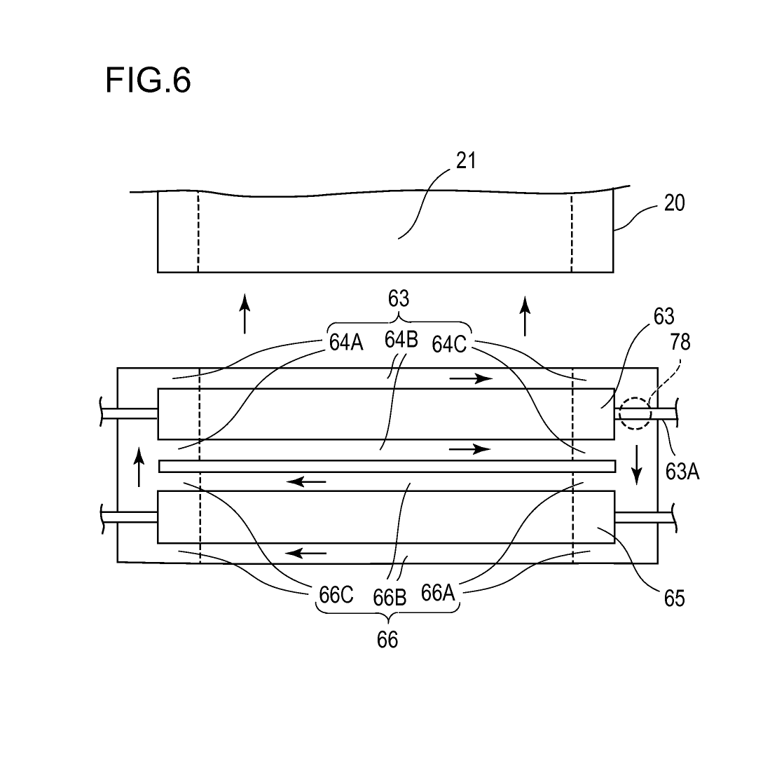

FIG. 2 is a cross-sectional view of assistance in explaining the development apparatus shown in FIG. 1, FIG. 3 is an enlarged view of the main part of FIG. 2, FIG. 4 is a schematic view of assistance in explaining the first developing roller shown in FIG. 3, FIG. 5 is a schematic view of assistance in explaining the second developing roller shown in FIG. 3, and FIG. 6 is a schematic view of the developer circulation section shown in FIG. 2.

As shown in FIG. 2, the development apparatus 10 is equipped with the first developing roller 20, the second developing roller 40, a developer supply section 60, a removing part 48 (refer to FIG. 4), and a developer recovery section 70, all of which contained in a main unit chassis 12. The removing part 48 has a function to remove the developer adsorbed in the second developing roller 40.

As shown in FIGS. 3 and 4, the first developing roller 20 is provided adjacent to the photoreceptor drum 142 and is equipped with a sleeve 22 and a fixed magnetic pole 30, in such a manner as to adsorb the developer by means of its magnetic force from the developer supply section 60.

The sleeve 22 is non-magnetic and rotated around the rotational axis 24. The fixed magnetic pole 30 is disposed inside the sleeve 22 and has a plurality of fan-shaped magnetic poles 31-35, and a fan-shaped non-magnetic part 38. A space is provided between the inner circumference of the sleeve 22 and the outer circumference of the fixed magnetic pole 30 in order to allow the sleeve 22 to rotate.

The magnetic pole 31 is an N-pole used for adsorbing the developer on the sleeve 22. The magnetic poles 32, 33, and 34 are an S-pole, an N-pole, and an S-pole respectively, and are used to transport upward the developer adsorbed by the magnetic pole 31 as the sleeve 22 rotates. The magnetic pole 35 is an N-pole, and delivers the developer by a repulsing magnetic field generated in conjunction with the magnetic pole 31 from the sleeve 22 to the S-Pole of the opposing second developing roller 40. This way, the developer is transferred approximately 100% to a sleeve 42.

In other words, the developer adsorbed on the sleeve 22 is transferred with the rotation action of the sleeve 22 onto the photoreceptor drum 142, thus developing the latent image formed on the photoreceptor drum 142. When the developer on the sleeve 22 is made to approach the second developing roller 40 by means of the rotation action of the sleeve 22 after the latent image formed on the photoreceptor drum 142 is developed or after passing the developing nip point, the developer is removed from the sleeve 22 and is delivered onto the sleeve 42 by means of the magnetic core 35.

The non-magnetic part 38 is made of a non-magnetic material and is located between the magnetic poles 31 and 35, which are N-poles. The non-magnetic part 38 can be constituted of a space.

The second developing roller 40, as shown in FIGS. 3 and 5, is located on the downstream side of the first developing roller 20 relative to the rotation direction of the photoreceptor drum 142 and above the first developing roller 20, and is equipped with the sleeve 42 and the fixed magnetic pole 50, so that the developer is delivered from the first developing roller 20 (sleeve 22) by means of magnetic force. The developer recovery section 70 is disposed on the lateral side of the second developing roller 40.

The sleeve 42 is non-magnetic and rotated around a rotational axis 44. The fixed magnetic pole 50 is disposed inside the sleeve 42 and has a plurality of fan-shaped magnetic poles 51-55, and a fan-shaped non-magnetic part 58. A space is disposed between the inner circumference of the sleeve 42 and the outer circumference of the fixed magnetic pole 50 in order to allow the sleeve 42 to rotate.

The magnetic pole 51 is an S-pole, and is used for adsorbing (delivering) the developer removed from the first developing roller 20 (sleeve 22) onto the sleeve 42. The magnetic poles 52, 53, and 54 are N-, S-, and N-poles respectively, and are used to transport the developer adsorbed by the magnetic pole 51 upwardly as the sleeve 42 rotates.

The magnetic pole 55 is an S-pole, i.e., a removing pole that constitutes the removing part 48 used for removing from the sleeve 42 the developer, which is remaining without being consumed in the development area of the photoreceptor drum 142 that corresponds with the magnetic pole 53, by means of a repulsing magnetic field generated in coordination with the magnetic pole 51.

In other words, the developer adsorbed on the sleeve 42 is transported with the rotation action of the sleeve 42 onto the photoreceptor drum 142, thus developing the latent image formed on the photoreceptor drum 142. When the excess developer or the developer remaining on the surface of the sleeve 42 is made to approach the developer recovery section 70 by means of the rotation action of the sleeve 42 after the latent image formed on the photoreceptor drum 142 is developed or after passing the developing nip point, it is removed from the sleeve 22 by means of the magnetic pole (removing pole) 55.

The non-magnetic part 58 is made of a non-magnetic material and is located between the magnetic poles 51 and 55, which are S-poles. The non-magnetic part 58 can be constituted of a space.

The magnetic pole (removing pole) 55 should preferably be placed above a horizontal line L₁ (refer to FIG. 3) that passes through the rotational axis 44 of the sleeve 42 of the second developing roller 40 for smoothly removing the developer from the second developing roller 40. In order to suppress the developer removed from the second developing roller 40 from returning to the first developing roller 20 side, a tangent line L₂ (refer to FIG. 3) at the magnetic pole (removing pole) 55 should preferably pass the outside of the first developing roller 20.

The developer supply section 60 is used for supplying the developer to the first developing roller 20, and is equipped with a developer circulation section 62, a first regulating member 67, and a second regulating member 69.

The developer circulation section 62 is equipped with first and second screw conveyors 63 and 65, and circulates the developer in a substantially horizontal direction, while supplying a portion of the developer to the first developing roller 20. Moreover, as described later, the developer that is recovered by the developer recovery section 70 drops by gravity and is introduced into the developer circulation section 62.

In other words, the developer is supplied to the first developing roller 20 from the developer circulation section 62 where the developer is agitated while circulating substantially in a horizontal direction, and then is delivered from the first developing roller 20 to the second developing roller 40 located above by means of magnetic force, and the developer removed from the second developing roller 40 then drops by gravity to be introduced into the developer circulation section 62. Therefore, there is no mechanism to scoop up the developer upward against gravity in the circulation system of the developer, so that there is no chance of developer retention even in the range where images are formed at a high speed.

The first and second screw conveyors 63 and 65 are screw-type transporting members disposed beneath the first developing roller 20 for transporting the developer in one direction while agitating it. The first screw conveyor 63 is positioned between the first developing roller 20 and the second screw conveyor 65 to face again the first developing roller 20.

The transport directions of the first and second screw conveyors 63 and 65 are opposite to each other, in such a manner that the start side 64A and the end side 64C of the transport route 64 of the first screw conveyor 63 are respectively connected with the end side 66C and the start side 66A of the transport route 66 of the second screw conveyor 65 as shown in FIG. 6. An intermediate position 64B located between the start side 64A and the end side 64C of the transport route 64 of the first screw conveyor 63 faces against a developing area 21 of the first developing roller 20 in such a manner that the developer is supplied towards the developing area. A mark 66B denotes an intermediate position located between the end side 66C and the start side 66A of the transport route 66 of the second screw conveyor 65.

The location of the developer circulation section 62 where the recovered developer drops by gravity should preferably be placed within a range between the end side 64C of the transport route 64 of the first screw conveyor 63 and the end side 66C of the transport route 66 of the second screw conveyor 65 avoiding the area 64B where the developer flows out or the intermediate portion of the transport route 64 of the first screw conveyor 63. With such an arrangement, the recovered developer gets fully agitated before it reaches the intermediate portion 64B of the transport route 64 of the first screw conveyor 63.

The first regulating member 67 is disposed adjacent to the first developing roller 20 to be used for regulating the amount of the developer to be supplied to the first developing roller 20 from the developer circulation section 62.

The first regulating member 67 can be constituted in such a manner as to regulate the amount of the developer to be adsorbed by the first developing roller 20 based on the gap between the surface of the sleeve 22 of the first developing roller 20 and the first developing roller side end 68 of the first regulating member 67 . The first regulating member 67 should preferably located below a line L₃ (refer to FIG. 3) that passes through the rotational axis 24 of the sleeve 22 of the first developing roller 20 and the rotational axis 63A of the first screw conveyor 63. With such an arrangement, it is possible to regulate the amount of the developer efficiently. It can also prevent any excessive residence of the developer left after the regulation, thus minimizing the stress on the developer.

The second regulating member 69 is used for regulating the space capacity that defines the volume of the developer that can reside between the first developing roller 20 and the first screw conveyor 63. With such an arrangement, the amount of the developer that exists in the vicinity of the first developing roller 20 can be controlled. The second regulating member 69 can be constituted, for example, of a protruding part located between the first developing roller 20 and the first screw conveyor 63. With such an arrangement, the distance D between the first developing roller 20 and the first developing roller 63 should preferably be larger than 9 mm for reducing a pitch irregularity based on the difference in pressure of a blade of the first screw conveyor 63.

The developer recovery section 70 is used for recovering the developer removed from the sleeve 42 of the second developing roller 40, and is equipped with a guide member 72, a third screw conveyor 76, and an opening 78 (refer to FIG. 6).

The guide member 72 has a slope 73 in order for the developer to slide down by gravity for the removed developer can be securely recovered. The third screw conveyor 76 is a screw-type transporting member used for transporting the developer, which is recovered as a result of sliding on the slope 73, in one direction while agitating it. The opening 78 is used for introducing the developer, which is transported by the third screw conveyor 76, into the developer circulation section 62 by gravity.

The angle θ₁ (refer to FIG. 3) between a horizontal line L₄ that passes through the second developing roller side end 74 of the slope 73, and a line L₅ that passes through the second developing roller side end 74 and the rotational axis 77 of the third screw conveyor 76 should preferably be larger than 30 degrees. With such an arrangement, the removed developer can be smoothly recovered.

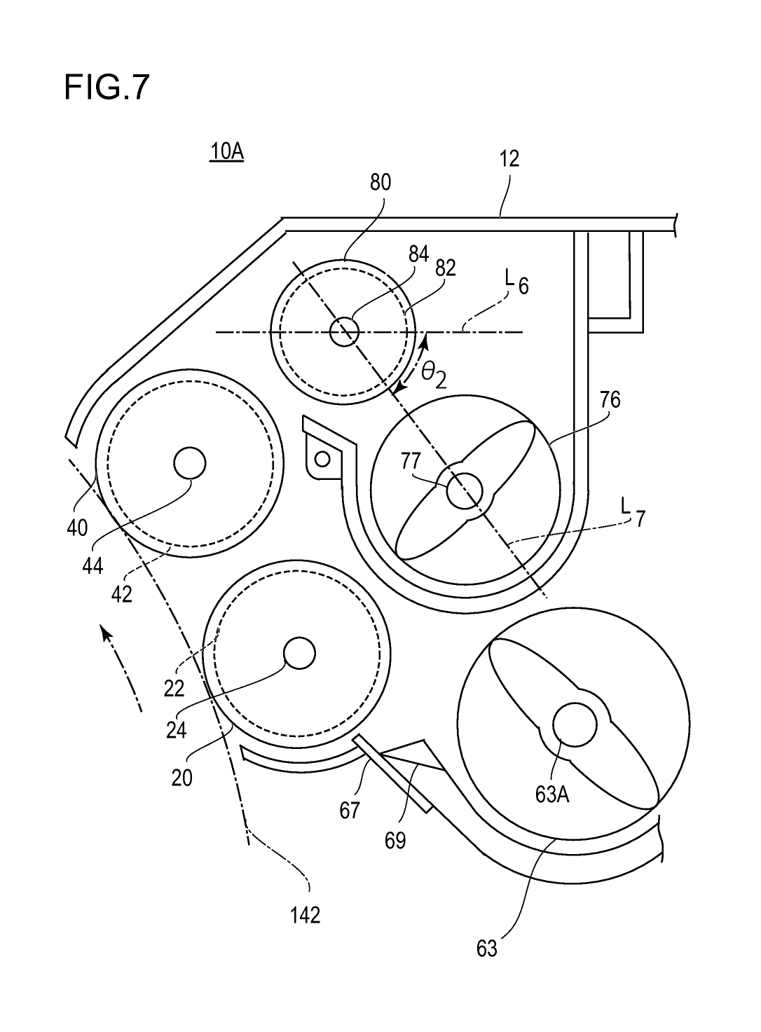

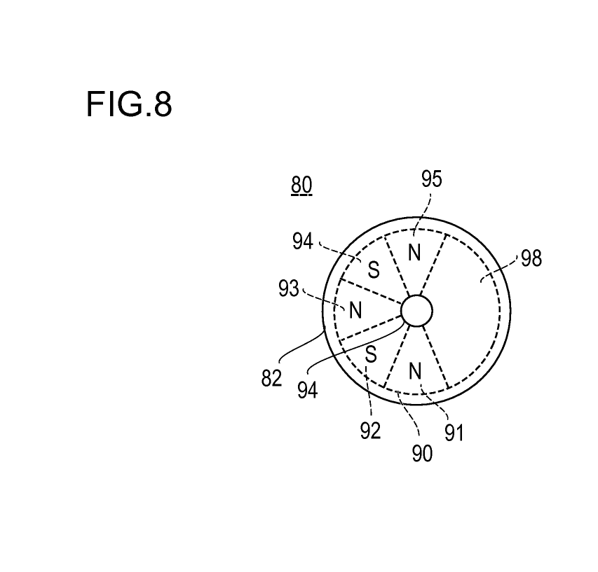

FIG. 7 is a cross-sectional view of assistance in explaining a modification according to the embodiment of the present invention, and FIG. 8 is a schematic view of assistance in explaining the removing roller shown in FIG. 7.

The developer removed from the sleeve 42 of the second developing roller 40 does not necessarily have to be introduced into the third screw conveyor 76 using the guide member 72 (the slope 73) , but rather can be removed by means of a removing roller 80 as a development apparatus 10A according to an modification shown in FIG. 7.

The removing roller 80 is located above the space between the second developing roller 40 and the third screw conveyor 76, and is equipped with a sleeve 82 and a fixed magnetic pole 90 (refer to FIG. 8) in order to receive the developer from the second developing roller 40 force based on the magnetic force.

The sleeve 82 is non-magnetic and rotated around a rotational axis 84. The fixed magnetic pole 90 is disposed inside the sleeve 82 and has a plurality of fan-shaped magnetic poles 91-95, and a fan-shaped non-magnetic part 98. A space is provided between the inner circumference of the sleeve 82 and the outer circumference of the fixed magnetic pole 90 in order to allow the sleeve 82 to rotate.

The magnetic pole 91 is an N-pole, and is used for adsorbing the developer removed from the second developing roller 40 (sleeve 42) onto the sleeve 82. The magnetic poles 92, 93, and 91 are an S-pole, an N-pole, and an S-pole respectively, and are used to transport downward the developer adsorbed by the magnetic pole 93 as the sleeve 82 rotates. The magnetic pole 91 is an N-pole and a removing pole used for removing the developer, which is adsorbed on the sleeve 82, from the sleeve 82 by means of a repulsing magnetic field generated in coordination with the magnetic pole 93.

In other words, the developer adsorbed by the sleeve 82 is transported downward by means of the rotation action of the sleeve 82, and is removed from the sleeve 82 as it approached the third screw conveyor 76 by means of the magnetic pole (removing pole) 95, and drops by gravity onto the third screw conveyor 76 located below. With such an arrangement, the removed developer can be securely recovered.

The non-magnetic part 98 is made of a non-magnetic material and is located between the magnetic poles 91 and 95, which are N-poles. The non-magnetic part 38 can be constituted of a space.

The developer on the sleeve 82 should preferably be removed from the sleeve 82 at a position below a horizontal line L₆ that passes through the rotational axis 84 of the sleeve 82 (refer to FIG. 7). With such an arrangement, the developer on the sleeve 82 drops smoothly toward the third screw conveyor 76 by gravity, the removed developed agent can be securely recovered.

The angle θ₂ (refer to FIG. 7) between a horizontal line L₆ that passes through the rotational axis 84 of the sleeve 82 of the removing roller 80, and a line L₇ that passes through the rotational axis 84 of the sleeve 82 of the removing roller 80 and the rotational axis 77 of the third screw conveyor 76 should preferably be larger than 30 degrees. With such an arrangement, the developer removed from the removing roller 80 can be smoothly recovered.

According to the present embodiment, the developer, which flows out from the developer circulation section where the developer is agitated while circulating substantially in a horizontal direction, is delivered to the second developing roller located above the first developing roller, from the first developing roller by magnetic force, and the developer, which is removed from the second developing roller, drops by gravity to be introduced into the developer circulation section. Consequently, there is no mechanism to scoop up the developer upward against gravity in the recovery circulation system of the developer, so that there is no chance of developer retention even in the range where images are formed at a high speed. Moreover, since the developer on the second developing roller is removed substantially 100% by the guide member 72 (the slope 73) or the removing roller 80, the amount of the developer on the second developing roller that does not have any layer forming part can be prevented from increasing. Thus, it is possible to provide a development apparatus that is capable of recovering the developer from the sleeve, circulating it, and supplying it to the sleeve in a stable manner even in the range where images are formed at a high speed.

Moreover, the image forming apparatus equipped with said development apparatus is capable of suppressing the occurrence of a defect such as improper density in an image visualized by the toner contained in the developer as it is capable of recovering and circulating the developer in a stable manner even in the range where images are formed at a high speed. Thus, it is possible to provide an image forming apparatus capable of suppressing the occurrence of a defect in an image even in the range where images are formed at a high speed.

It is obvious that this invention is not limited to the particular embodiments shown and described above but may be variously changed and modified without departing from the technical concept of this invention. For example, the image forming apparatus discussed here is not limited to copying machines and is applicable to printers dedicated for printing, or MFP (Multi-Function Peripheral) equipment having copying, printing and scanning functions, or facsimile machines, etc. It is applicable also to a case where the development apparatus is equipped with three or more developing rollers, or a case where it includes both the guide member (slope) and the removing roller.

What is claimed is:

1. A development apparatus equipped with a plurality of developing rollers for developing and visualizing an electrostatic latent image formed on an image carrier by means of toner contained in a developer, comprising:
a first developing roller for adsorbing the developer by magnetic force;
a supply section for supplying the developer to said first developing roller;
a second developing roller disposed on a downstream side of said first developing roller relative to a rotation direction of said image carrier and above said first developing roller, to which the developer is delivered from said first developing roller by magnetic force;
a removing part that removes off the developer adsorbed on said second developing roller; and
a recovery section used for recovering the developer that is removed, wherein
said supply section comprises a developer circulation section wherein the developer supplied to said first developing roller is agitated while circulating substantially in a horizontal direction, and a first regulating member that is disposed adjacent to said first developing roller and regulates an amount of the developer that flows out from said developer circulation section and adsorbed by said first developing roller, wherein
the developer that is recovered by said recovery section drops by gravity and is introduced into said developer circulation section.

2. The development apparatus claimed in claim 1, wherein said developer circulation section comprises first and second screw-type transporting members that transport the developer in one direction while agitating the developer, wherein
said first and second screw-type transporting members are disposed below said first developing roller,
said first screw-type transporting member is positioned between said first developing roller and said second screw-type transporting member,
the transport directions of said first and second screw-type transporting members are opposite to each other, and
a start side and an end of said first screw-type transporting member are respectively connected with an end side and a start side of said second screw-type transporting member, wherein
an intermediate position located between the start side and the end side of a transport route of said first screw-type transporting member faces against a developing area of said first developing roller in such a manner that the developer flows out toward said developing area.

3. The development apparatus claimed in claim 2, wherein a location of said developer circulation section where the recovered developer drops by gravity to be introduced therein is included within a range between the end side of the transport route of said first screw-type transporting member and the end side of the transport route of said second screw-type transporting member.

4. The development apparatus claimed in claim 2, wherein said first developing roller comprises a non-magnetic sleeve that is rotated, and a fixed magnetic pole disposed inside said sleeve having a plurality of magnetic poles, wherein said first regulating member is located below a line that passes through a rotational axis of the sleeve of said first developing roller and a rotational axis of said first screw-type transporting member.

5. The development apparatus claimed in claim 4, wherein said first regulating member regulates an amount of the developer adsorbed by said first developing roller based on a gap between a surface of the sleeve of said first developing roller and said first regulating member.

6. The development apparatus claimed in claim 4, wherein said second developing roller comprises a non-magnetic sleeve that is rotated, and a fixed magnetic pole disposed inside said sleeve having a plurality of fan-shaped magnetic poles, wherein said magnetic pole includes a removing pole for removing the adsorbed developer from said sleeve by means of a repulsive magnetic field, and said removing pole constitutes said removing part disposed above a horizontal line that passes through the rotational axis of said sleeve.

7. The development apparatus claimed in claim 6, wherein said fixed magnetic pole further comprises a fan-shaped non-magnetic part made of a non-magnetic material, wherein said non-magnetic part is disposed between said removing pole and a magnetic pole for generating a repulsive magnetic field in conjunction with said removing pole.

8. The development apparatus claimed in claim 6, wherein a tangent line at said removing pole passes through an outside of said first developing roller.

9. The development apparatus claimed in claim 4, wherein said supply section further comprises a second regulating member for regulating a space capacity that defines a volume of the developer that can reside between said first developing roller and said first screw-type transporting member.

10. The development apparatus claimed in claim 9, wherein said second regulating member is composed of a protruding part located between said first developing roller and said first screw-type transporting member.

11. The development apparatus claimed in claim 9, wherein a distance between said first developing roller and said first screw-type transporting member is equal or more than 9 mm.

12. The development apparatus claimed in claim 4, wherein said recovery section comprises a guide member having a slide on which the removed developer slides down by gravity, a third screw-type transporting member that transports the developer, which is recovered by sliding down said slope, in one direction while agitating the developer, and an opening used for dropping by gravity and introducing the developer, which is transported by said third screw-type transporting member, into said developer circulation section.

13. The development apparatus claimed in claim 12, wherein an angle between a horizontal line that passes through a second developing roller side end of said slope and a line that passes through said end and a rotational axis of said third screw-type transporting member is equal or more than 30 degrees.

14. The development apparatus claimed in claim 4, wherein
said recovery section comprises a removing roller that receives the developer from said second developing roller by means of magnetic force, a third screw-type transporting member that is disposed below said removing roller and transports the developer in one direction while agitating the developer, and an opening used for dropping by gravity and introducing the developer, which is transported by said third screw-type transporting member, into said developer circulation section, wherein
said removing roller comprises a non-magnetic sleeve that is rotated, and a fixed magnetic pole disposed inside said sleeve having a plurality of fan-shaped fixed magnetic poles, and said magnetic pole includes a removing pole for removing the adsorbed developer from said sleeve by means of a repulsive magnetic field, wherein
the developer on said sleeve is removed from said sleeve at a position below a horizontal line that passes through the rotational axis of said sleeve and drops toward said third screw-type transporting member by gravity.

15. The development apparatus claimed in claim 14, wherein an angle between a horizontal line that passes through the rotational axis of the sleeve of said removing roller and a line that passes through the rotational axis of the sleeve of said removing roller and a rotational axis of said third screw-type transporting member is equal or more than 30 degrees.

16. An image forming apparatus comprising:
a development apparatus equipped with a plurality of developing rollers for developing and visualizing an electrostatic latent image formed on an image carrier by means of toner contained in a developer; and
an image carrier on which an electrostatic latent image to be developed is formed by said development apparatus, wherein said development apparatus comprising:
a first developing roller for adsorbing the developer by magnetic force;
a supply section for supplying the developer to said first developing roller;
a second developing roller disposed on a downstream side of said first developing roller relative to a rotation direction of said image carrier and above said first developing roller, to which the developer is delivered from said first developing roller by magnetic force;
a removing part that removes off the developer adsorbed on said second developing roller; and
a recovery section used for recovering the developer that is removed, wherein
said supply section comprises a developer circulation section wherein the developer supplied to said first developing roller is agitated while circulating substantially in a horizontal direction, and a first regulating member that is disposed adjacent to said first developing roller and regulates an amount of the developer that flows out from said developer circulation section and adsorbed by said first developing roller, wherein
the developer that is recovered by said recovery section drops by gravity and is introduced into said developer circulation section.
